(19) United States
(12) Patent Application Publication
(10) Pub. No.: US 2025/0231075 A1
(43) Pub. Date: Jul. 17, 2025

(54) SPRING SYSTEM FOR LEAK TEST STATION

(71) Applicant: FCA US LLC, Auburn Hills, MI (US)

(72) Inventor: Hongyu Wang, Shanghai (CN)

(21) Appl. No.: 18/415,186

(22) Filed: Jan. 17, 2024

(51) Int. Cl. G01M 3/02

(52) U.S. Cl. CPC G01M 3/025

(57) ABSTRACT

A leak test fixture for a cylinder head or block has a plurality of side face sealing plates, a bottom face sealing plate and a top face sealing plate. The sealing plates collectively seal a part, such as a cylinder head or block, for testing. A plurality of biasing mechanisms on at least one sealing plate. The plurality of biasing mechanism compresses toward a face of the sealing plates during clamping of the plates during testing. The plurality of biasing mechanisms rebound after testing moving the cylinder block/head way from the sealing plates.

### FIELD

The present disclosure relates to part testing and, more particularly, to a vehicle part testing system for leak detection.

### BACKGROUND

This section provides background information related to the present disclosure which is not necessarily prior art.

Various types of systems and apparatus are utilized to test for leakage of vehicle parts such as cylinder heads, cylinder block and battery tray housings. These devices utilize various sealing plates to seal the part so that it can be tested for leaks. Generally, the parts have an overall box configuration and require sealing plates for the top, bottom and four sides. After testing, when the part is released from the fixture, the pressure to retract away from the part or to remove the sealing plate overcomes the part. Thus, when the cylinder heads/block is to be removed, due to the negative pressure between the sealing plate and the cavities of the cylinder head/block, it is not a smooth process. This invisible and uncertain force may lead to scratching the part or even the part being dropped from the fixture damaging the part.

Thus, there is a need to remove the invisible and uncertain force from the part prior to the removal of the part from the fixture or jig.

The present disclosure provides the fixture or jig with a system for removing the force from the part, cylinder head or block so that damage to the part does not occur. The present disclosure provides the art with a system that removes the part, cylinder head or block from the sealing plates without causing damage to the part. The present disclosure provides a biasing mechanism that compresses during testing of the part and extends away from the part to enable removal of the sealing plate from the part.

### SUMMARY

This section provides a general summary of the disclosure, and is not a comprehensive disclosure of its full scope or all of its features.

According to an aspect of the disclosure, a leak test fixture for a cylinder head or block comprises a plurality of side face sealing plates, a bottom face and top face sealing plate where the sealing plates collectively seal the part, such as a cylinder head or block, for testing. A plurality of biasing mechanisms are positioned on the sealing plates. The plurality of biasing mechanisms compress toward the face of the sealing plates during clamping of the plates during testing. The plurality of biasing mechanisms rebounding after testing ejecting the part, cylinder block/head, away from the sealing plates. The biasing mechanisms may be in the top or bottom sealing plates. The biasing mechanisms generally are compression springs. The sealing plates, including the top and bottom, include a plurality of bores to receive the plurality of biasing members or springs. Each of the plurality of biasing members or springs include a pad for resting against the part such as a cylinder head or block to prevent marring of the part. The pad is generally a soft material such as rubber, felt or the like.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure.

FIG. 1 illustrates a perspective schematic view of a testing fixture.

FIG. 2 illustrates a schematic perspective view of a sealing plate.

FIG. 3 illustrates a schematic view of the fixture in an unclamped position.

FIG. 4 illustrates a schematic view of the fixture in a clamped position.

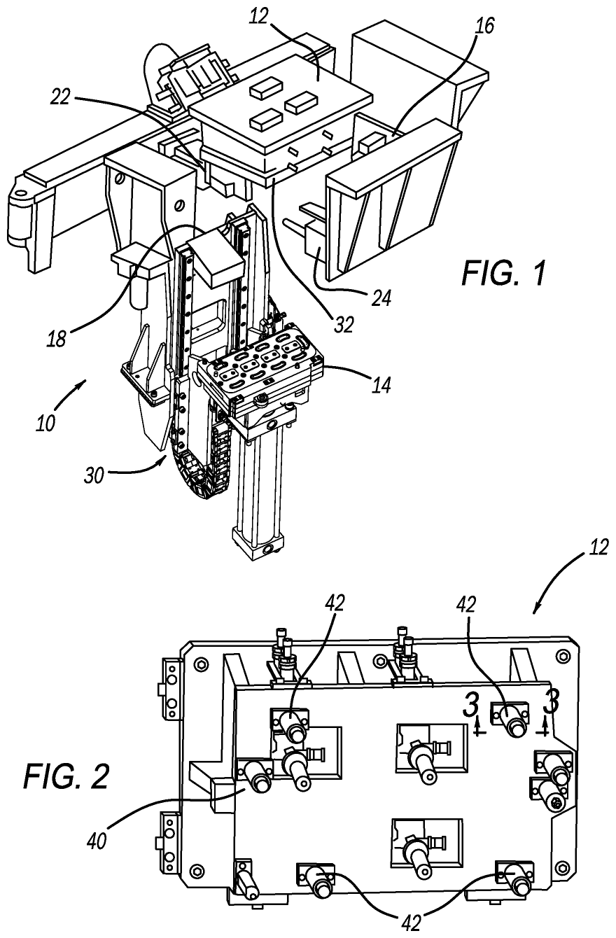

Corresponding reference numerals indicate corresponding parts throughout the several views of the drawings.

### DETAILED DESCRIPTION

Example embodiments will now be described more fully with reference to the accompanying drawings.

Turning to the figures, a leak test station is illustrated and designated with the reference numeral 10. The leak test station 10 includes a top sealing plate 12, a bottom sealing plate 14, a front sealing plate 16, a rear sealing plate 18 and exhaust face sealing plate 22 and an intake sealing face plate 24 for covering the sides of the part. The leak test station 10 includes a hydraulic system 30 for bringing the sealing plates against a part 32, such as a cylinder head, cylinder block, transmission housing, motor housing and battery tray housing.

The hydraulic system 30, once the part 32 is in place, is activated so that the sealing plates 14-22 contact the part 32 in a sealing position. The sealing plates 14-22 may include a spring biasing system 40 as will be explained herein.

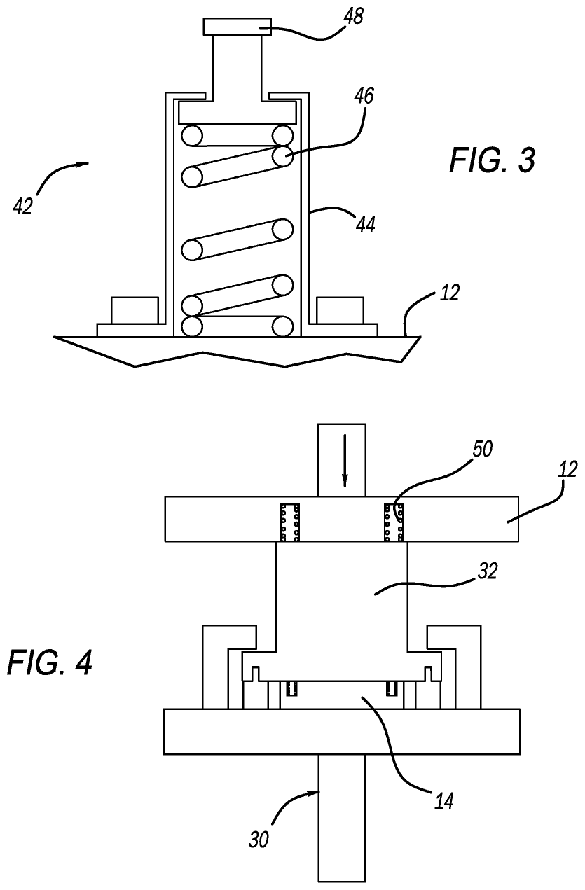

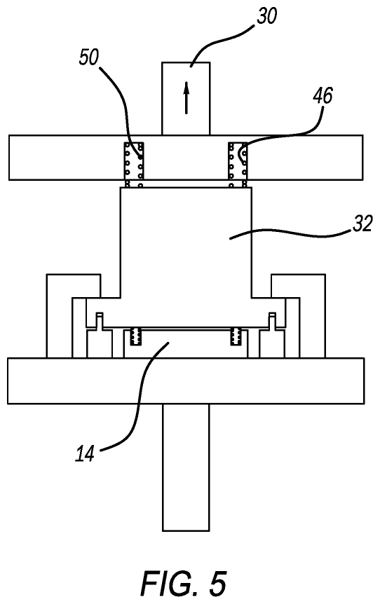

As illustrated in FIG. 2, on the top sealing plate 12, the spring biasing system 40 is positioned on the plate 12. The biasing system 40 includes a plurality of individual biasing members 42. The biasing members 42 may include a housing 44, a compression spring 46 positioned within the housing 44. A pad 48, manufactured from a soft material, such as rubber, felt, plastic or the like, is positioned and connected at the end of the spring 46. The plate 12 may include a bore 50 to receive the spring as illustrated in FIGS. 3 and 4.

The compression spring 46 extends from the plate in an unclamped position. The pad 48 rests against the part 32 to prohibit damage or marring of the part. As the hydraulic system 30 is activated, the sealing plates 14-22 press against the part 32, cylinder block 32. As this occurs, the springs 46 are compressed into the plates as illustrated in FIG. 3. The part is tested for linkage and after the test, the hydraulic force is removed. As this occurs, the compression springs 46 rebound or expand moving the plate away from the part 32 to remove the uncertain force that may be caused by a negative pressure holding the sealing plate against the part. Thus, the springs 46 with pads 48 may be positioned on all of the sealing plates 14-24 so that upon removal of the hydraulic force, the part is positioned away from the sealing plates so that it can be removed from the test fixture. The part 32 is contacted by the soft material pad 48 so that damage to the part does not occur. Also, the springs 46 have a desired spring force to push the plates away from the part so that sticking to the part does not occur. Thus, this removes the possibility of the part securing to the sealing plates and damage occurring to the part.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. A leak test fixture for a cylinder head or block comprising:
a plurality of side face sealing plates, a bottom face sealing plate and a top face sealing plate, the sealing plates collectively sealing a part, such as a cylinder head or block, for testing; and
a plurality of biasing mechanisms on at least one sealing plate, the plurality of biasing mechanism compressing toward a face of the sealing plate during clamping of the plates during testing and the plurality of biasing mechanisms rebounding after testing ejecting the part, cylinder block/head, way from the sealing plates.

2. The leak test fixture for a cylinder head or block of claim 1, wherein the biasing mechanisms are compression springs.

3. The leak test fixture for a cylinder head or block of claim 1, wherein the top and/or bottom sealing plate includes a plurality of bores for receiving the plurality of biasing members.

4. The leak test fixture for a cylinder head or block of claim 1, wherein each of the plurality of biasing members includes a pad for resting against the cylinder block/head.

5. The leak test fixture for a cylinder head or block of claim 4, wherein the pad is a soft material such as rubber, plastic or the like.

6. The leak test fixture for a cylinder head or block of claim 1, wherein the biasing mechanism includes a housing positioned on the sealing plate.
